(19) United States
(12) Patent Application Publication
(10) Pub. No.: US 2008/0280008 A1
(43) Pub. Date: Nov. 13, 2008

(54) Soy Cotyledon Fibers and Methods For Producing Fibers

(75) Inventors: Jeffrey C. Evans, St. Michael, MN (US); Todd W. Gusek, Crystal, MN (US); Ian C. Purtle, Plymouth, MN (US)

Correspondence Address: PERKINS COIE LLP/CARGILL, INC., P.O. BOX 1247, SEATTLE, WA, 98111-1247, US

(73) Assignee: Cargill, Incorporated, Wayzata (MN)

(21) Appl. No.: 11/908,268

(22) PCT Filed: Mar. 9, 2006
(86) PCT No.: PCT/US2006/008983

§ 371 Date: May 1, 2008

Related U.S. Application Data
(60) Provisional application No. 60/659,984, filed on Mar. 9, 2005.

(51) Int. Cl. A23L 1/20; A23L 2/52

(52) U.S. Cl. 426/598; 426/634

(57) ABSTRACT

The disclosure relates to methods for producing treated aqueous soy cotyledon fiber suspensions and to the resultant aqueous soy cotyledon fiber suspensions. In some embodiments, the methods involve treating an aqueous soy cotyledon fiber suspension with both an oxidizing agent and a base in any order. The disclosure also relates to use of the treated aqueous soy cotyledon suspensions in preparing foods and beverages.

### CROSS REFERENCE TO RELATED APPLICATIONS

This application claims priority to co-pending U.S. provisional patent application Ser. No. 60/659,984 filed Mar. 9, 2005, the entire contents of which are incorporated herein by reference.

### FIELD OF THE INVENTION

The present invention relates to processes for preparing and treating fibers, particularly soy cotyledon fibers; treated soy cotyledon fibers; and uses of the treated soy cotyledon fibers in the preparation of foods and beverages, such as yogurt, processed meat and the like.

### BACKGROUND

Soy cotyledon fiber (SCF) is a commercially available product. For example, SCF is commercially available from Fuji Oil Company, Solae (PTI), and Ralston Purina Company, among others, as KERRY ISO FIBER, SOLAE FIBRIM 1020, SOLAE FIBRIM 2000, and FUJI SOYAFIBRE-S. Typically, soy cotyledon fibers have a high content of total dietary fiber (TDF), about 50% or more, dry basis; have a low content of soluble fiber, about 5%, dry basis; and have a soy protein content, up to about 35%, dry basis.

There are various methods known for obtaining soy cotyledon fibers. Any technique is suitable for generating SCF. Among the known techniques is a process for obtaining SCF during the processing of whole soybeans. In general, whole soybeans are first dried and cracked and then conditioned and flaked to facilitate oil extraction to remove soy hulls. The flakes are extracted with hexane to remove crude oil and then flash desolventized to remove residual hexane, producing white flakes. The white flakes are then further processed using mild sodium hydroxide solution to extract the protein and precipitate the insoluble, wet SCF that typically contains about 15% SCF solids in suspension.

To enhance use of the soy cotyledon fiber in foods and beverages, however, it has been found that certain organoleptic properties related to the SCF should be altered. More particularly, it would be desirable, especially for use in foods and beverages, to reduce the gritty or chalky mouthfeel, minimize the beany or cereal off-flavors, and lighten the tan color.

### DETAILED DESCRIPTION OF THE PREFERRED AND EXEMPLARY EMBODIMENTS

The present invention, in a first embodiment, relates to a method comprising treating a suspension of wet soy cotyledon fiber, containing preferably from about 1 to about 15% solids, with a combination of a base such as peroxide and an oxidizing agent such as alkali metal hydroxide, a carbonate, a bicarbonate, ammonium hydroxide, or a mixture thereof, to produce an SCF suspension having a pH greater than 7, preferably about 9 to about 12, and to the resultant SCF suspension. If desired, the resultant SCF suspension may be dried, and/or ground. Optionally, the wet SCF suspension may be treated to reduce particle size of the SCF, by any method such as ultrasound, wet grinding, or preferably homogenization, prior to introducing the oxidizing agent and the base. The wet suspension of SCF may be obtained in any manner, such as, for example, adding water to dry SCF.

In a second embodiment, the present invention relates to a method comprising treating a suspension of wet soy cotyledon fiber, containing preferably from about 1 to about 15% solids, with a combination of an oxidizing agent such as a peroxide and a base such as an alkali metal hydroxide, ammonium hydroxide, a carbonate, a bicarbonate or a mixture thereof, to produce an SCF suspension having a pH of about 9 to about 12, and then reducing the pH of the SCF suspension to about 7 to about 9, and the resultant SCF suspension having a pH of about 7 to about 9. If desired, the resultant SCF suspension having a pH of about 8 to about 9, may be dried, and/or ground. Optionally, the wet SCF suspension may be treated to reduce the particle size of the SCF, by any method such as ultrasound, wet milling or preferably homogenization, prior to introducing the oxidizing agent and the base. The pH of the SCF suspension may be reduced from about 9 to about 12, to about 7 to about 9, by any suitable means, such as by ultrasound, or preferably, by heating. Preferably the pH will be about 8.5.

In a third embodiment, the present invention relates to a method comprising treating a suspension of wet soy cotyledon fibers, containing preferably from about 1 to about 15% solids, with a combination of an oxidizing agent such as a peroxide and a base such as an alkali metal hydroxide, ammonium hydroxide, a carbonate, a bicarbonate or a mixture thereof, to produce an SCF suspension having a pH of about 9 to about 12, and then reducing the pH of the SCF suspension to about 7 to about 9 by any means such as heating, and then neutralizing the pH of the SCF suspension to a pH of about 7.0, and to the resultant SCF suspension having a pH of about 7.0. If desired, the resultant SCF suspension having a pH of about 7.0 may be dried, and/or ground. Optionally, the wet SCF suspension may be treated to reduce the particle size of the SCF, by any method such as ultrasound, wet milling or preferably homogenization, prior to introducing the oxidizing agent and the base. The pH of the SCF suspension may be reduced from about 7 to about 9, to about 7.0 by neutralization with any suitable acid, such as an organic or preferably inorganic acid, such as citric acid, hydrochloric acid, or the like.

In a fourth embodiment, the present invention relates to a method comprising treating a suspension of wet soy cotyledon fibers, containing preferably from about 1 to about 15% solids, with a combination of an oxidizing agent such as a peroxide and base such as an alkali metal hydroxide, ammonium hydroxide, a carbonate, a bicarbonate or a mixture thereof, to produce an SCF suspension having a pH of about 9 to about 12, and then reducing the pH of the SCF suspension to a pH of about 7 to about 9. Thereafter, the pH of the SCF suspension is neutralized to a pH of about 7.0 and then the SCF suspension having a pH of about 7.0 is subjected to solvent extraction or steam distillation. In this embodiment, the invention is also related to the SCF suspension resulting from this embodiment wherein the SCF suspension having a neutralized pH of about 7.0 is solvent extracted or steam distilled. If desired, the resultant solvent extracted or steam distilled SCF suspension having a pH of about 7.0 may be dried and/or ground. Optionally, the wet SCF suspension may be treated to reduce the particle size of the SCF, by any method such as ultrasound, wet milling, or preferably homogenization, prior to introducing the oxidizing agent and the base. The pH of the SCF suspension may be reduced to about 7 to about 9 by any suitable means such as heating or ultrasound, or the like. The pH of the resulting SCF suspension may then be reduced to about 7.0 by neutralizing with any suitable acid, such as an organic or inorganic and such as hydrochloric acid. The SCF suspension may be subjected to solvent extraction to assist in the reduction of color pigments to thereby lighten the color of the SCF suspension; and to also assist in at least partially extracting volatile flavor compounds that generally impart a beany flavor, thereby yielding an SCF suspension having a bland taste. Alternatively, the SCF suspension may be steam distilled to assist in the reduction by vaporization of volatile flavor compounds that impart beany flavor, and thereby yield an SCF suspension having a bland taste. The steam distillation may be carried out for example by heating, with steam, the SCF suspension to a temperature of about 285° F., and then spraying the heated SCF suspension into a closed chamber under vacuum to effect flash cooling and vaporization of flavor volatiles.

In a fifth embodiment, the present invention relates to a method comprising subjecting a suspension of wet soy cotyledon fibers to either solvent extraction or to steam distillation. The suspension of wet SCF preferably contains about 1 to about 15% solids. The SCF suspension may be subjected to solvent extraction to assist in reduction of color pigments to lighten the color of the SCF suspension, and also to assist in at least partially extracting volatile flavor compounds that generally impart a beany flavor, thereby yielding an SCF suspension having a bland taste. Alternatively, the SCF suspension may be subjected to steam distillation to reduce by vaporization, volatile flavor compounds that impart beany flavors thereby yielding an SCF suspension having a bland taste. The SCF suspension may be steam distilled using any conventional technique, such as, for example, by heating the SCF suspension, with steam, to a temperature of about 285° F., and then spraying the heated SCF suspension into a closed chamber under a vacuum to effect flash cooling and thereby vaporize flavor volatiles. In this embodiment, the invention is also related to the SCF suspensions resulting from the solvent extraction and the steam distillation of the suspension of wet SCF. If desired, SCF suspension resulting from either the solvent extraction or steam distillation procedures, may be dried and/or ground.

In the embodiments herein the following features are applicable.

Wet SCF or wet soy cotyledon fibers, relates to an aqueous suspension preferably comprising about 1 to about 15% solids. More preferably, the SCF suspension comprises about 10 to about 13% solids.

Particle size reduction of the suspension of wet SCF may be carried out using any conventional technique. For example, particle size reduction may be achieved by using ultrasound, wet milling, or preferably homogenization. In one embodiment, homogenization is carried out under an exemplary condition of total pressure of 2000 psi, preferably in 2 stages, the first at 1500 psi and the second at 500 p.s.i. Examples of equipment for wet grinding include a stone grinder and a colloid mill.

Any oxidizing agent may be used, particularly those acceptable for food use. Suitable examples of oxidizing agents include, but are not limited to, barium peroxide, benzoyl peroxide, calcium hypochlorite, hydrogen peroxide, magnesium peroxide, perchloric acid, ozone, potassium bromate, and sodium peroxide. The peroxide that may be used includes, preferably, hydrogen peroxide, benzoyl peroxide and other suitable peroxides. Any base may be used. Suitable bases include an alkali metal hydroxide, such as sodium hydroxide, potassium hydroxide, or the like, ammonium hydroxide, a carbonate or a bicarbonate. Suitable carbonates or bicarbonates that may be used include, but are not limited to, sodium carbonate, sodium bicarbonate, potassium carbonate, potassium bicarbonate, ammonium carbonate, ammonium bicarbonate, or a mixture thereof. The oxidizing agent and the base are used in combination, in an amount sufficient that the pH of the suspension of wet SCF, which is the starting material that typically has a pH of about 7, is raised to a pH greater than 7, and preferably to a pH of about 9 to about 12, preferably about 10.5. The oxidizing agent and base may be added in any manner and in any order. The oxidizing agent may be added first or second, or both the oxidizing agent and the base may be added simultaneously. Preferably, the oxidizing agent is added, followed by addition of base.

The pH of the suspension of wet SCF may be reduced by any suitable manner. Exemplary of the techniques that are suitable for reducing pH include but are not limited to, ultrasound, or preferably by heating the SCF suspension. In a specific embodiment, the heating of the SCF suspension may be carried out at a temperature of about 60° C., for a period of about 4 hours. Under the conditions, herein, the pH of an SCF suspension may be reduced from about 9 to about 12, to a pH of about 7 to about 9, preferably to a pH of about 8.5.

Neutralization of the pH of the SCF suspension relates to adjusting the pH of the SCF suspension to about 7. The neutralization of the SCF suspension herein may be achieved by adding an acid to adjust the pH to 7. Any acid may be used for the neutralization. Examples include organic acids such as citric acid or the like, and inorganic acids such as hydrochloric acid, or the like.

Solvent extraction of the SCF suspension as used herein is carried out to assist in reduction of color pigments from the SCF suspension to lighten the color of the SCF suspension, and also to at least partially extract volatile flavor compounds that generally impart a beany flavor, thereby yielding an SCF suspension having a bland taste. Suitable solvents that may be used include, but are not limited to, water, ethanol, acetone, ethyl acetate, 2-propanol (isopropanol), hexane, n-butanol, mixtures thereof, and the like.

Steam distillation as used herein relates to reducing by vaporization from the SCF suspension, volatile flavor compounds that impart beany flavors, thereby yielding an SCF suspension having a bland taste. The steam distillation may be carried out in any known manner. In a specific embodiment the steam distillation is achieved by heating the SCF suspension, with steam, to a temperature of about 285° F. and then spraying the heated SCF suspension into a closed chamber, under vacuum, to effect flash cooling and vaporization of the flavor volatiles.

The following are expectations regarding the SCF suspension described in the first, second, third, fourth and fifth embodiments of the disclosure herein, relative to an unprocessed SCF suspension. It is expected that the SCF suspension of the first and second embodiments will have improved grittiness and color.

It is expected that the SCF suspension of the third embodiment will have a bland taste.

It is expected that the SCF suspension of the fourth and fifth embodiments will have improved beany/cereal flavor and improved color when solvent extraction is used.

The invention will be more readily understood by reference to the following examples. There are, of course, many other forms of the invention which will become obvious to one skilled in the art, once the invention has been fully disclosed, and it will accordingly be recognized that the example is given for the purpose of illustration only, and is not to be construed as limiting the scope of this disclosure in any way.

### Example 1

In this example, the starting soy cotyledon fiber (SCF) material comprised 85% water, 0.6% soluble dietary fiber, 7.65% insoluble dietary fiber, 5.4% protein, and 0.6% fat.

400 grams of dried SCF was loaded onto a No. 200 mesh USA standard testing sieve (75 micron cut-off) and shaken for 10 minutes on a Ro-Tap sieve shaker. The material that passed through the sieve was used. 1300 grams of tap water was placed into a 2-liter plastic beaker and agitation using an Ika Labortechnik lab mixer at 500 rpm was started. The SCF from the sieve was suspended by adding slowly into the water with continuous agitation until the SCF was dispersed. The viscosity of the resulting SCF suspension was 60 cps at 27° C., as measured using a Brookfield Model HAT viscometer.

The SCF suspension was homogenized at about 20° C. by pumping through a 2-stage APV Gaulin Model 15 MR laboratory homogenizer, at a total pressure of 2000 psi (1500 psi first stage, 500 psi second stage). The viscosity of the homogenized SCF suspension was about 5000 cps at 28° C., and the pH was about 7.1, as measured using a Thermo Orion Model 520 pH meter.

752 grams of the homogenized SCF suspension was placed into a 2-liter plastic beaker, and then 14.7 grams of hydrogen peroxide solution (36% hydrogen peroxide, by weight) was added. This equates to about 5.29 grams of hydrogen peroxide per 100 grams of dry SCF. The SCF suspension was stirred by hand until homogenous. Then, 3.5 grams of sodium hydroxide solution (50% sodium hydroxide, by weight) was added, and stirred by hand until homogeneous. The sodium hydroxide equates to about 1.75 grams of sodium hydroxide per 100 grams of dry SCF. The pH of the treated SCF suspension, immediately following addition of sodium hydroxide was about 10.5. The SCF suspension was covered and heated in a Neslab Model GP-400 water bath to about 60° C. The temperature of the sample was maintained for four (4) hours while mixing once per hour with a spatula to maintain homogeneity. The pH after heating was 8.2.

Thereafter, the pH of the SCF suspension was neutralized by adding hydrochloric acid. The acid was distributed with a spatula. Sufficient acid was added until the pH was about 7.0. The viscosity, after neutralization, was about 20,600 cps at 25° C.

About 100 grams of the pH-neutralized SCF suspension was dispersed in a 2-liter plastic beaker containing about 1 liter of isopropanol, with stirring, which was continued for 30 minutes. The stirring was stopped, and the insoluble material precipitated for about 45 minutes until the supernate was clear. The supernate was decanted by pouring off as much solvent as possible without disturbing the precipitate. The precipitate was placed onto a Whatman #4 filter paper, and filtered under vacuum to further remove solvent. The wet filter cake was spread on an aluminum pan (8 inches wide by 16 inches long) to enhance solvent evaporation. The sample was then dried in a Shel Lab Model 1430 vacuum oven at about 65° C. and 27 inches Hg vacuum for one (1) hour. The dried SCF was ground in a Retsch Grindomix Model GM 200 for 30 seconds at 2000 rpm. The results are reported in the following Table 1.

TABLE 1

| PROPERTY | UNPROCESSED SCF | PROCESSED SCF |
|---|---|---|
| Color (Hunter Lab Values)^{a} | | |
| L | 78.36 | 85.57 |
| a | 1.06 | −0.18 |
| b | 13.62 | 5.63 |
| Flavor^{b} | Beany | Nearly Bland |
| Mouthfeel^{b} | Gritty | Slightly Chalky |
| Density (g/mL) | 0.62 | 0.13 |

^{a}Measured using a HunterLab ColorQuest XE colorimeter.
^{b}The flavor and mouthfeel were evaluated using sensory means after dispersing approximately 3 grams of SCF into 147 grams of cold, skim milk.

The above data reveal that the processed SCF suspension was characterized by improved color, flavor and mouthfeel. The increased value for (L) indicates that the SCF was more white. The lower (a) value indicates a more green color. The lower (b) value indicates a more blue color.

The processed SCF suspensions herein are expected to have utility in foods and beverages. For example, it is expected that the processed SCF suspension will be useful in meat products, batters, breadings, yogurt, dairy products, beverages, nutrition bars, bakery products, and coatings. It is also expected that the processed SCF suspensions herein will have utility in pharmaceutical applications.

It should be clearly understood that the forms of disclosure herein described are illustrative only and are not intended to limit the scope of the invention. The present invention includes all modifications falling within the scope of the disclosure and the following claims.

We claim:

1. A method for preparing a second aqueous soy cotyledon fiber (SCF) suspension having a pH value of greater than 7, comprising:
a) providing a first aqueous soy cotyledon fiber suspension,
b) introducing an oxidizing agent into the first aqueous SCF suspension,
c) introducing base into the first aqueous SCF suspension, and
d) recovering the second aqueous SCF suspension having a pH value of greater than 7.

2. The method according to claim 1 wherein the first aqueous SCF suspension is subjected to particle size reduction, prior to introduction of the oxidizing agent and the base.

3. A method for preparing a third aqueous soy cotyledon fiber (SCF) suspension having a pH value of about 7 to about 9, comprising:
a) providing a first aqueous soy cotyledon fiber suspension,
b) introducing an oxidizing agent into the first aqueous SCF suspension,
c) introducing a base into the first aqueous SCF suspension,
d) producing a resultant second aqueous SCF suspension having a pH value of about 9 to about 12,
e) reducing the pH value of the second aqueous SCF suspension to provide a third aqueous SCF suspension having a pH value of about 7 to about 9, and
f) recovering the third aqueous SCF suspension having a pH value of about 7 to about 9.

4. The method according to claim 3 wherein the pH value of the second aqueous SCF suspension is reduced by heating the second aqueous SCF suspension.

5. The method according to claim 3 wherein the first aqueous SCF suspension is subjected to particle size reduction, prior to introduction of the oxidizing agent and the base.

6. A method for preparing a fourth aqueous soy cotyledon fiber (SCF) suspension having a pH value of about 7 comprising:
a) providing a first aqueous soy cotyledon fiber suspension,
b) introducing an oxidizing agent into the first aqueous SCF suspension,
c) introducing a base into the first aqueous SCF suspension,
d) producing a resultant second aqueous SCF suspension having a pH value of about 9 to about 12,
e) reducing the pH value of the second aqueous SCF suspension having a pH value of about 9 to about 12, to provide a third aqueous SCF suspension having a pH value of about 7 to about 9, and
f) neutralizing the pH value of the third aqueous SCF suspension having a pH value of about 7 to about 9 to provide a fourth aqueous SCF suspension having a pH value of about 7, and
g) recovering the fourth aqueous SCF suspension having a pH value of about 7.

7. The method according to claim 6 wherein the first aqueous SCF suspension is subjected to particle size reduction, prior to introduction of the oxidizing agent and the base.

8. The method according to claim 6 wherein the pH value of the second aqueous SCF suspension is reduced by heating the second aqueous SCF suspension to provide the third aqueous SCF suspension having a pH value of about 7 to about 9.

9. The method according to claim 6 further comprising solvent extracting the fourth aqueous soy cotyledon fiber suspension having a pH value of about 7.

10. The method according to claim 6 further comprising steam distilling the fourth aqueous soy cotyledon fiber suspension having a pH value of about 7.

11. A product produced in accordance with the method of claim 1.

12. A product produced in accordance with the method of claim 3.

13. A product produced in accordance with the method of claim 6.

14. A product produced in accordance with the method of claim 9.

15. A product produced in accordance with the method of claim 10.

16. The method according to claim 1 further comprising drying the second aqueous soy cotyledon fiber suspension having a pH value of greater than 7.

17. The method according to claim 3 further comprising drying the third aqueous soy cotyledon fiber suspension having a pH value of about 7 to about 9.

18. The method according to claim 6 further comprising drying the fourth aqueous soy cotyledon fiber suspension having a pH value of about 7.

19. The method according to claim 9 further comprising drying the solvent extracted fourth aqueous soy cotyledon fiber suspension having a pH value of about 7.

20. The method according to claim 10 further comprising drying the steam distilled fourth aqueous soy cotyledon fiber suspension having a pH value of about 7.

21. A product produced in accordance with the method of claim 16.

22. A product produced in accordance with the method of claim 17.

23. A product produced in accordance with the method of claim 18.

24. A product produced in accordance with the method of claim 19.

25. A product produced in accordance with the method of claim 20.

26. A composition comprising the product of claim 11 and a component selected from the group consisting of a food and a beverage.

27. A composition comprising the product of claim 12 and a component selected from the group consisting of a food and a beverage.

28. A composition comprising the product of claim 13 and a component selected from the group consisting of a food and a beverage.

29. A composition comprising the product of claim 14 and a component selected from the group consisting of a food and a beverage.

30. A composition comprising the product of claim 15 and a component selected from the group consisting of a food and a beverage.

31. A composition comprising the product of claim 21 and a component selected from the group consisting of a food and a beverage.

32. A composition comprising the product of claim 22 and a component selected from the group consisting of a food and a beverage.

33. A composition comprising the product of claim 23 and a component selected from the group consisting of a food and a beverage.

34. A composition comprising the product of claim 24 and a component selected from the group consisting of a food and a beverage.

35. A composition comprising the product of claim 25 and a component selected from the group consisting of a food and a beverage.

36. A method comprising:
a) providing an aqueous soy cotyledon fiber suspension, and
b) solvent extracting the aqueous SCF suspension to reduce color pigments and at least partially extract volatile beany flavor imparting compounds.

37. The method according to claim 36 wherein the aqueous SCF suspension is subjected to particle size reduction, prior to the solvent extraction.

38. A product produced in accordance with the method of claim 36.

39. A composition comprising the product of claim 38 and a component selected from the group consisting of a food and a beverage.

40. The method according to claim 36 further comprising drying the solvent extracted aqueous SCF suspension.

41. A product produced in accordance with the method of claim 40.

42. A composition comprising the product of with claim 41 and a component selected from the group consisting of a food and a beverage.

43. A method comprising:
a) providing an aqueous soy cotyledon fiber suspension, and
b) steam distilling the aqueous SCF suspension to reduce, by vaporization, volatile flavor compounds that impart a beany flavor.

44. A product produced in accordance with the method of claim 43.

45. A composition comprising the product of claim 44 and a component selected from the group consisting of a food and a beverage.

46. The method according to claim 43 further comprising drying the steam distilled aqueous SCF suspension.

47. A product produced in accordance with the method of claim 46.

48. A composition comprising the product of claim 47 and a component selected from the group consisting of a food and a beverage.

49. The method according to claim 43 wherein the aqueous SCF suspension is subjected to particle size reduction, prior to the steam distillation.

50. A method for preparing a treated aqueous soy cotyledon fiber (SCF) suspension comprising:
a) providing a first aqueous soy cotyledon fiber suspension,
b) introducing an oxidizing agent into the first aqueous SCF suspension,
c) introducing a base into the first aqueous SCF suspension,
d) producing a resultant second aqueous SCF suspension having a pH value of about 9 to about 12,
e) reducing the pH value of the second aqueous SCF suspension having a pH value of about 9 to about 12, to provide a third aqueous SCF suspension having a pH value of about 7 to about 9,
f) neutralizing the pH value of the third aqueous SCF suspension having a pH value of about 7 to about 9 to provide a fourth aqueous SCF suspension having a pH value of about 7,
g) solvent extracting the fourth aqueous soy cotyledon fiber suspension having a pH value of about 7, to provide a solvent extracted aqueous SCF suspension, and
h) drying the solvent extracted aqueous SCF suspension.

51. The method according to claim 50 wherein the oxidizing agent is hydrogen peroxide, the base is sodium hydroxide, the oxidizing agent is introduced prior to introducing the base into the first aqueous SCF suspension, the pH of the third aqueous SCF suspension is neutralized by using hydrochloric acid and the fourth aqueous SCF suspension is solvent extracted using 2-propanol as the solvent.

52. The method according to claim 50 wherein the first aqueous SCF suspension is subjected to particle size reduction, prior to introduction of the oxidizing agent and the base.

53. A product produced in accordance with the method of claim 50.

54. A product produced in accordance with the method of claim 51.

55. A composition comprising the product of claim 53 and a component selected from the group consisting of a food and a beverage.

56. A composition comprising the product of claim 54 and a component selected from the group consisting of a food and a beverage.
